(19) United States
(12) Patent Application Publication
(10) Pub. No.: US 2011/0011895 A1
(43) Pub. Date: Jan. 20, 2011

(54) Pump Dispenser With Dip Tube Having Wider Tip Portion

(76) Inventors: Tomotaka Michitsuji, Osaka (JP); Manivannan Kandasamy, Kobe (JP)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/837,186

(22) Filed: Jul. 15, 2010

Related U.S. Application Data
(60) Provisional application No. 61/225,574, filed on Jul. 15, 2009.

(51) Int. Cl. B67D 7/58; B67D 7/78

(52) U.S. Cl. 222/382; 222/464.1

(57) ABSTRACT

Disclosed is a pump dispenser with a dip tube for dispensing a liquid product from a package, wherein the dip tube comprises a tube portion and a tip portion at the lower end of the tube portion, and the dip tube has a shape such that it is spread at the tip portion. The pump dispenser of the present invention provides improved dispensability of the liquid products.

### CROSS REFERENCE TO RELATED APPLICATIONS

This application claims the benefit of U.S. Provisional Application Ser. No. 61/225,574 filed on Jul. 15, 2009.

### FIELD OF THE INVENTION

The present invention relates to a pump dispenser with a dip tube having a wider tip. The pump dispenser of the present invention provides improved dispensability of the contents.

### BACKGROUND OF THE INVENTION

There exist a variety of packages with pump dispensers for evacuation of liquid contents contained within the packages. The pump dispenser is usually sealingly fitted to a mouth of the package, e.g., by a screw-on cap or a snap-on cap. With each press of the pump head, a certain amount of the contents is pumped up. Liquid products are, for example, hair shampoo, hair conditioner, hand soap, body shampoo, and cosmetic lotions.

However, there is a desire for reducing liquid product residue at the time of aeration. Aeration herein, which can be referred to as “sputtering”, means a phenomena that air in packages is dispensed concurrently along with the liquid products and/or is dispensed without any liquid product. Consumers generally expect that such aeration phenomena may occur toward the end of the package usage cycle when most of the contents have already been dispensed for use. However, it has been found that the aeration occurs when a relatively large amount of the contents remains in the package, especially, when liquid products have relatively high viscosities, when package shape isn't a cylinder, i.e., its horizontal cross sectional view isn't always circle from its top to bottom, and/or when room temperature is relatively low. Such relatively large amount of residue at the time of aeration may be perceived by consumers, for example, as inconvenient and/or as inferior package functionality.

Thus, there remains a desire for reducing liquid product residue at a point of aeration, especially when liquid products have relatively high viscosities.

None of the existing art provides all of the advantages and benefits of the present invention.

### SUMMARY OF THE INVENTION

The present invention relates to a pump dispenser with a dip tube for dispensing a liquid product from a package, wherein the dip tube comprises a tube portion and a tip portion at the lower end of the tube portion, and the dip tube has a shape such that it is spread at the tip portion. The present invention provides improved dispensability of the liquid product.

These and other features, aspects, and advantages of the present invention will become better understood from a reading of the following description, and appended claims.

### BRIEF DESCRIPTION OF THE DRAWINGS

While the specification concludes with claims particularly pointing out and distinctly claiming the invention, it is believed that the invention will be better understood from the following description of the accompanying figure in which:

FIG. 1 illustrates a perspective view of the first embodiment of a pump dispenser of the present invention.

FIG. 2 illustrates a front view of the first embodiment.

FIG. 3 illustrates a back view of the first embodiment.

FIG. 4 illustrates a side view of the first embodiment.

FIG. 5 illustrates a side view of the first embodiment, and further illustrates the width W of the cut of the tip portion.

FIG. 6 illustrates a usage of the first embodiment in one exemplified package.

FIG. 7 illustrates a perspective view of the package shown on FIG. 6.

FIG. 8 illustrates a front view of the package shown on FIG. 6.

FIG. 9 illustrates a back view of the package shown on FIG. 6.

FIG. 10 illustrates top view of the package shown on FIG. 6.

FIG. 11 illustrates a bottom view of the package shown on FIG. 6.

FIG. 12 illustrates a cross sectional view of the package, taken along X-X in FIG. 8.

FIG. 13 illustrates a perspective view of the second embodiment of a pump dispenser of the present invention.

FIG. 14 illustrates a side view of the second embodiment.

FIG. 15 illustrates a side view of the third embodiment of a pump dispenser of the present invention.

FIG. 16 illustrates a side view of the fourth embodiment of a pump dispenser of the present invention.

FIG. 17 illustrates a perspective view of a pump dispenser on market.

FIG. 18 illustrates a front view of the pump dispenser on market.

FIG. 19 illustrates a back view of the pump dispenser on market.

FIG. 20 illustrates a side view of the pump dispenser on market.

### DETAILED DESCRIPTION OF THE INVENTION

While the specification concludes with the claims particularly pointing and distinctly claiming the invention, it is believed that the present invention will be better understood from the following description.

All percentages, parts and ratios are based upon the total weight of the hair care compositions of the present invention and all measurements made are at 25° C., unless otherwise specified. All such weights as they pertain to listed ingredients are based on the active level and, therefore, do not include carriers or by-products that may be included in commercially available materials, unless otherwise specified.

Herein, “comprising” means that other steps and other ingredients which do not affect the end result can be added. This term encompasses the terms “consisting of” and “consisting essentially of”.

Herein, “mixtures” is meant to include a simple combination of materials and any compounds that may result from their combination.

All measurements are understood to be made at 25° C. and at ambient conditions, where “ambient conditions” means conditions under about one atmosphere of pressure and at about 50% relative humidity.

### Pump Dispenser

Pump dispensers of the present invention, used for dispensing a liquid product from a package, comprise a dip tube 2 wherein the dip tube 2 comprises a tube portion 21 and a tip portion 22 at the lower end of the tube portion 21, and the dip tube 2 has a shape such that it is spread at the tip portion 22. The pump dispensers of the present invention usually further comprises a pump functionality portion 1. The dip tube 2 and the pump functionality portion 1 can be separate parts which are assembled to form pump dispenser. Alternatively, dip tube 2 and the pump functionality portion 1 can be one part.

### Dip Tube

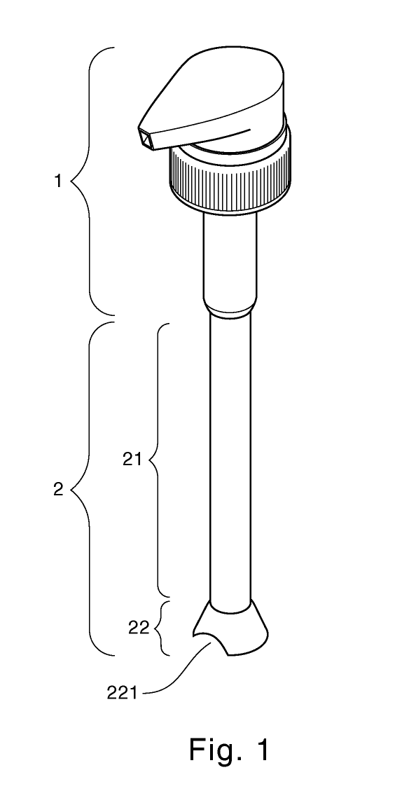

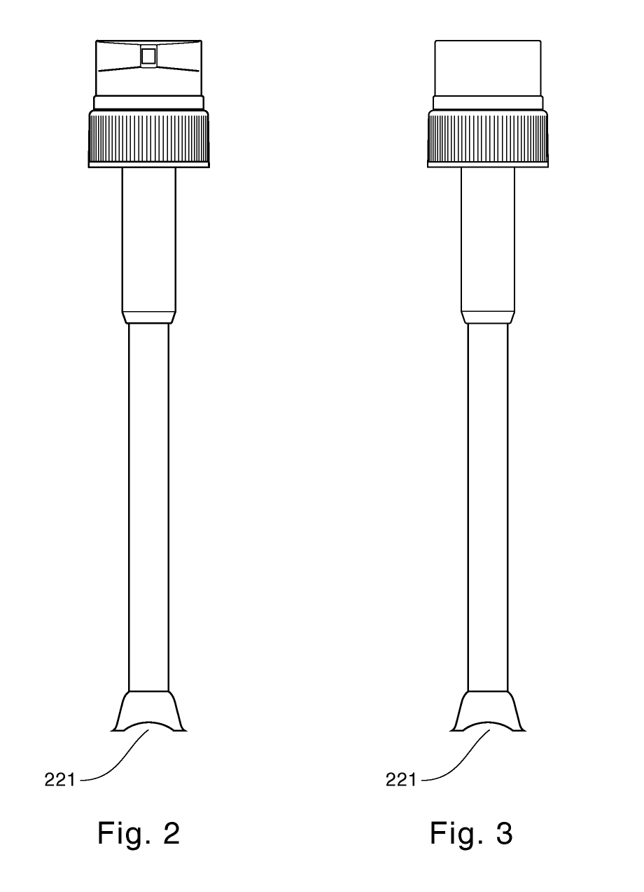

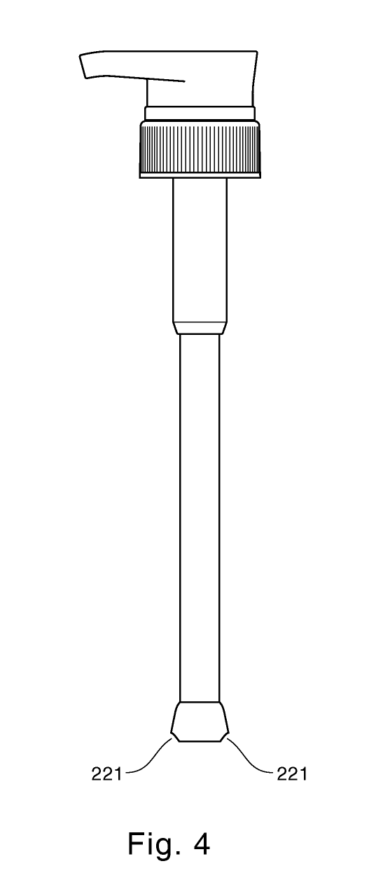

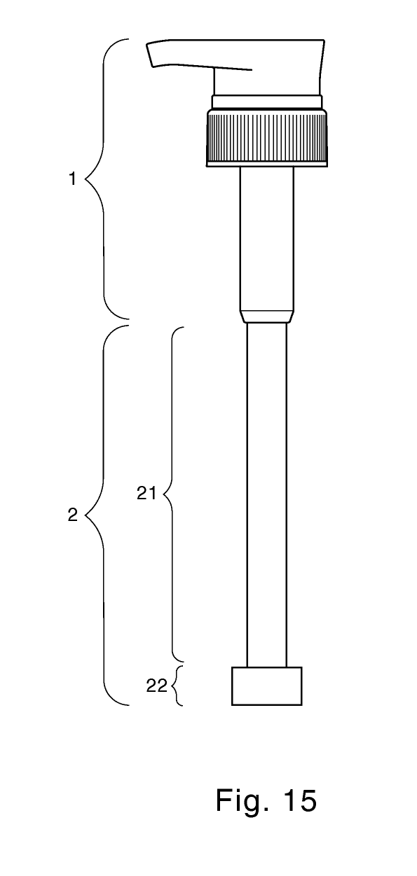

In the dip tube 2 of the present invention, the tube portion 21 can have almost same inner diameter toward its lower end where the tip portion 22 is formed, and wherein the inner diameter of the lower end of the tip portion 22 is bigger than the inner diameter of the tube portion 21. In such case, the tip portion 22 is either: spread toward its lower end, for example, as shown on FIGS. 1-6, 13 and 14; or having almost same inner diameter toward its lower end, for example, as shown on FIG. 15.

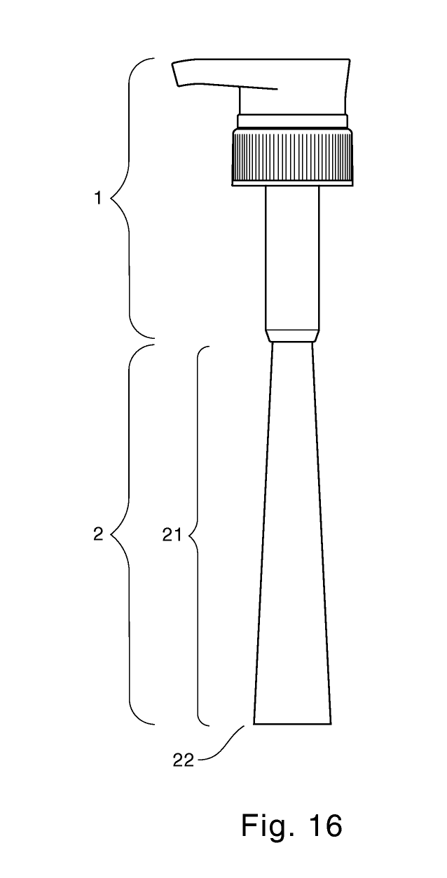

Alternatively, in the dip tube 2 of the present invention, the tube portion 21 can be gradually spread toward the lower end where the tip portion 22 is formed, for example, as shown in FIG. 16.

In the present invention, it is preferred that the tube portion 21 have almost same inner diameter toward its lower end where the tip portion 22 is formed, as exemplified in FIGS. 1-6, 13-15, in view of balance between dispensability and reduced product residue in the tube portion. In the present invention, it is also preferred that the tip portion 22 is spread toward its lower end, as exemplified in FIGS. 1-6, 13 and 14, in view of balance between dispensability and reduced product residue in the tip portion.

### Tube Portion

In preferred embodiments in which the tube portion 21 have almost same inner diameter toward its lower end, the inner diameter of the tube portion 21 is preferably from about 3 mm to about 30 mm, more preferably from about 5 mm to about 20 mm, still more preferably from about 7 mm to about 15 mm, in view of in view of balance between dispensability and reduced product residue in the tube portion. Too big diameter of the tube portion may cause (i) manufacturing difficulty especially when inserting the dip tube into the package and/or (ii) increased potential residue in the tube portion, while too small diameter may cause less improvement in dispensability, i.e., product residue reduction in the package.

Alternatively, in the embodiment in which the tube portion 21 is gradually spread toward the lower end where the tip portion 22 is formed, for example, as shown in FIG. 16, the inner diameter of the tube portion 21 is, at its narrowest portion, preferably from about 3 mm to about 30 mm, more preferably from about 5 mm to about 20 mm, still more preferably from about 7 mm to about 15 mm.

### Tip Portion

In preferred embodiments in which the tube portion 21 have almost same inner diameter toward its lower end, the tip portion 22 can have a length such that the ratio of the length of the tip portion 22 to the inner diameter of the tube portion 21 is preferably from about 0.3:1 to about 3:1, more preferably from about 0.5:1 to about 2:1, still more preferably from about 0.7:1 to about 1.5:1, in view of balance between dispensability and reduced product residue in the tip portion. Too long length of the tip portion may cause increased potential residue in the tip portion, while too short length of the tip portion may show less improvement in dispensability, i.e., product residue reduction in the package.

In preferred embodiments in which the tube portion 21 have almost same inner diameter toward its lower end, the lower end of the tip portion 22 can have an inner diameter such that the ratio of the inner diameter of the lower end of the tip portion 22 to the inner diameter of the tube portion 21 is preferably from about 1.2:1 to about 5:1, more preferably from about 1.5:1 to about 3:1, still more preferably from about 1.7:1 to about 2.5:1. In such embodiments, the inner diameter of the lower end of the tip portion 22 is preferably from about 5 mm to about 40 mm, more preferably from about 7 mm to about 30 mm, still more preferably from about 10 mm to about 25 mm, even more preferably from about 10 mm to about 22 mm. Too big diameter of the lower end of the tip portion may cause (i) manufacturing difficulty especially when inserting the dip tube into the package and/or (ii) increased potential residue in the tip portion, while too small diameter may show less improvement in dispensability, i.e., product residue reduction in the package.

Alternatively, in the embodiment in which the tube portion 21 is gradually spread toward the lower end where the tip portion 22 is formed, for example, as shown in FIG. 16, the lower end of the tip portion 22 can have an inner diameter such that the ratio of the inner diameter of the lower end of the tip portion 22 to the inner diameter of the narrowest portion of the tube portion 21 is preferably from about 1.2:1 to about 5:1, more preferably from about 1.5:1 to about 3:1, still more preferably from about 1.7:1 to about 2.5:1. In this embodiment, the inner diameter of the lower end of the tip portion 22 is preferably from about 5 mm to about 40 mm, more preferably from about 7 mm to about 30 mm, still more preferably from about 10 mm to about 25 mm, even more preferably from about 10 mm to about 22 mm.

### Cut

In the present invention, the tip portion 22 has preferably at least one cut 221, and more preferably two cuts, in view of dispensability, i.e., reduced product residue in the package. Number and direction of the cuts are described in more detail below together with package shapes.

The cut 221 can have a variety of shape including, for example, triangle-like and/or semicircular-like shape as shown on FIGS. 1-6, rectangular-like shape, slit-like shape, and so on. Preferably, the cut has a triangle-like shape, in view of dispensability, i.e., reduced product residue in the package.

In the preferred embodiments in which the tube portion 21 have almost same inner diameter toward its lower end, the height of each cut 221 is preferably from about 5% to about 150%, more preferably from about 10% to about 100%, still more preferably from about 15% to about 80%, even more preferably from about 15% to about 60%, further more preferably from about 15% to about 40% of the height of the tip portion 22, in view of dispensability, i.e., reduced product residue in the package.

Alternatively, in the embodiment in which the tube portion 21 is gradually spread toward the lower end where the tip portion 22 is formed, for example, as shown in FIG. 16, the height of each cut can be appropriately decided.

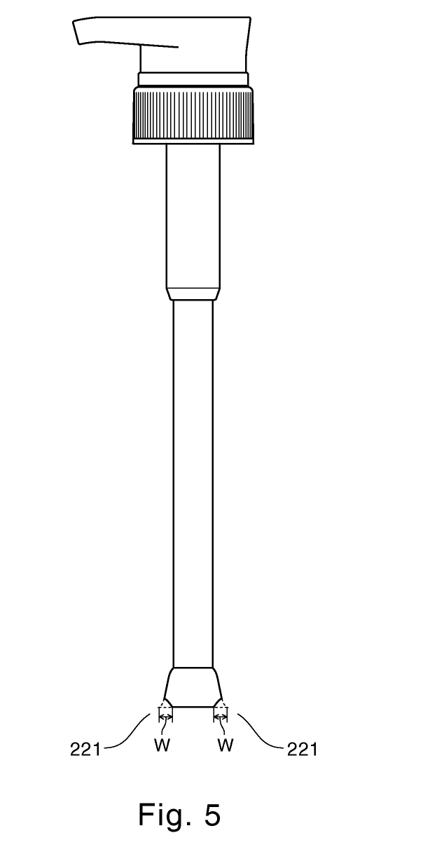

In any embodiment, the width of lower end of each cut (shown as “W” in FIG. 5) is preferably from about 10% to about 50%, more preferably from about 20% to about 40%, still more preferably from about 25% to about 35% of the width of the lower end of tip portion 22, in view of dispensability, i.e., reduced product residue in the package. What is meant by “width of the lower end of the cut” is, as shown in FIG. 5 as “W”, when seeing the cut from its side, the distance between: the far end of the lowest end of the tip portion before making the cut; and the lowest end of the cut after making the cut.

### Package

The pump dispenser of the present invention is suitable for a variety of packages, for example, those which horizontal cross sectional view are circular, oval, triangle, and rhombic shapes.

### Package Shape and Preferred Cut Features

It has been found by the present inventor that it is preferred to have a cut especially when package shape isn't a cylinder, i.e., its horizontal cross sectional view isn't always circle from its top to bottom. Furthermore, in the present invention, it is preferred to have a number of cuts which corresponds to a number of longer edges of the package. It is also preferred that the cut is facing approximately to the longer edge of the package. For example, it is preferred to have two cuts for oval and rhombic, and such two cuts are facing approximately to the two longer edges of the oval and rhombic shapes.

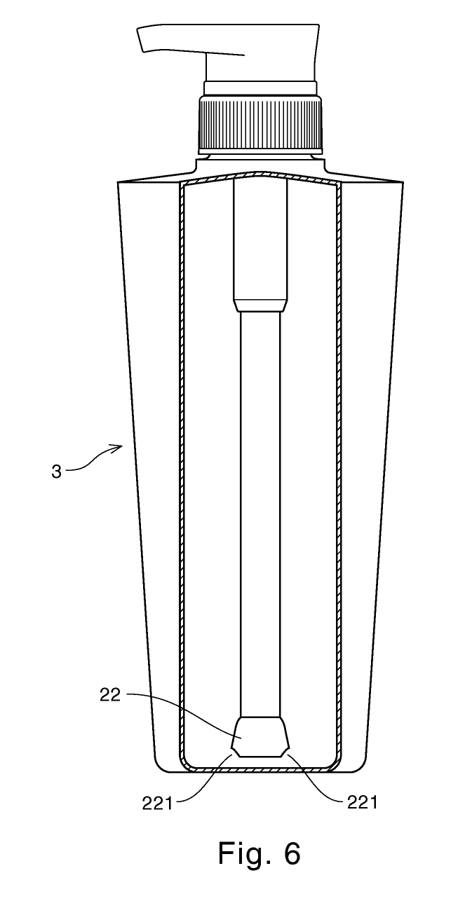

For example, in FIG. 6, the tip portion 22 has two cuts 221 in the package 3, and the package 3 has a rhombic shape at the top portion and a circular shape at the bottom portion, and the two cuts 221 are facing approximately to the two longer edges of the rhombic shape.

### Clearance Height

In the package, when the pump dispenser is tightly connected to the package, the lower end of the tip portion (which corresponds to the lower end of the dip tube) is placed at a little bit higher position than the inner bottom of the package, as shown in FIG. 6. The lower end of the dip tube is placed at a position of preferably from about 1 mm to about 20 mm, more preferably from about 2 mm to about 15 mm, still more preferably from about 5 mm to about 12 mm, even more preferably from about 7 mm to about 1 mm higher than the inner bottom of the package, in view of dispensability, i.e., reduced product residue in the package.

### Liquid Products

The pump dispenser of the present invention is suitable for any liquid products, for example: shampoos and/or cleansing for any substrates such as hair, body, hands, face, and/or hard surfaces including dishes and/or floors; conditioners, treatments, moisturizers, creams for hair, body, hands and/or face; and hair stylings, and so on.

The pump dispenser of the present invention is especially suitable for liquid products having a viscosity of preferably from about 2,000 mPa·s to about 200,000 mPa·s, more preferably from about 5,000 mPa·s to about 100,000 mPa·s, still more preferably from about 10,000 mPa·s to about 50,000 mPa·s more preferably from about 10,000 mPa·s to about 40,000 mPa·s, as measured at 25° C., by means of a Brookfield Viscometer at shear rate of 1.0 rpm.

### EXAMPLES

The following examples further describe and demonstrate embodiments within the scope of the present invention. The examples are given solely for the purpose of illustration and are not to be construed as limitations of the present invention, as many variations thereof are possible without departing from the spirit and scope of the invention. Where applicable, ingredients are identified by chemical or CTFA name, or otherwise defined below.

All measurements referred to herein are made at a room temperature.

### Product Dispensability

With respect to the pump dispensers of the present invention, product dispensability is evaluated by the following package, product and method. Details of the pump dispenser are shown below in Table 1. Results of the evaluation are shown below in Table 1.

### Package and Product

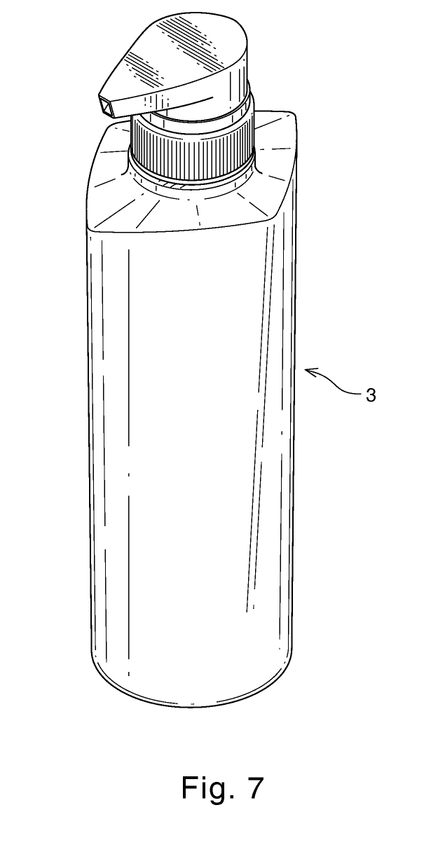

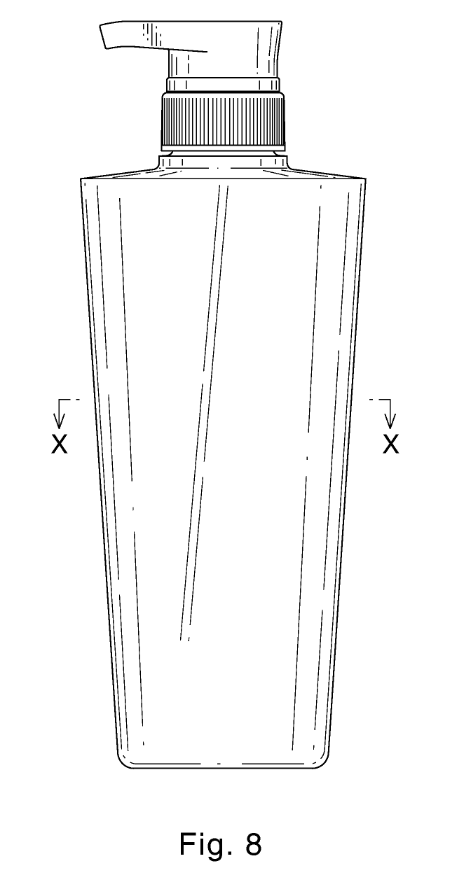

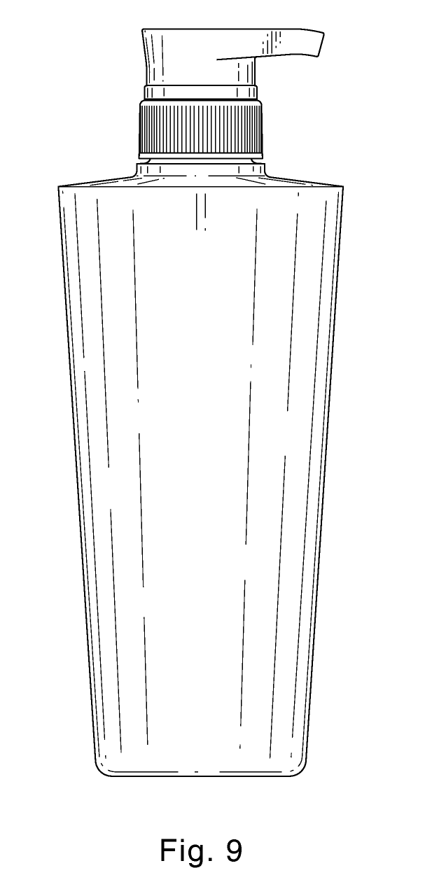

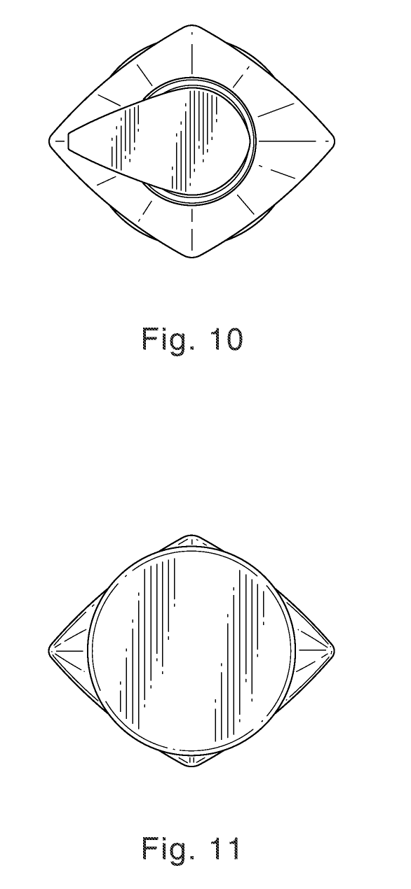

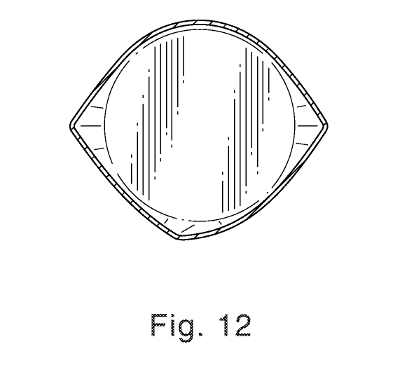

Package used in the evaluation has a shape as shown on FIGS. 7-12. The height from the bottom to top (where the package has a widest portion) is about 18 cm, the longer width at the top is 8.5 cm, the shorter width at the top is 7 cm, and the diameter of the bottom is about 6 cm. Liquid product used in the evaluation is a hair conditioner having a viscosity of 30,000 mPa·s.

### Method

(i) Putting an empty pump dispenser with an empty dip tube, into the above package filled with 500 g of the above product;

(ii) Dispensing out the products from the package, until the first aeration is observed;

(iii) Measuring the weight of the package all together with the pump dispenser, dip tube, and product residues inside thereof;

(iv) Weight of the product residue is calculated by the weight (iii) minus the total weight of an empty package, empty pump dispenser and empty dip tube; and

(v) Above (i) to (iv) were repeated five times for each example, and its average is calculated.

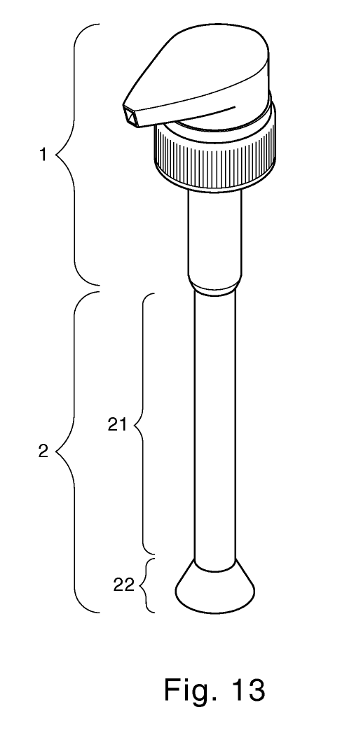

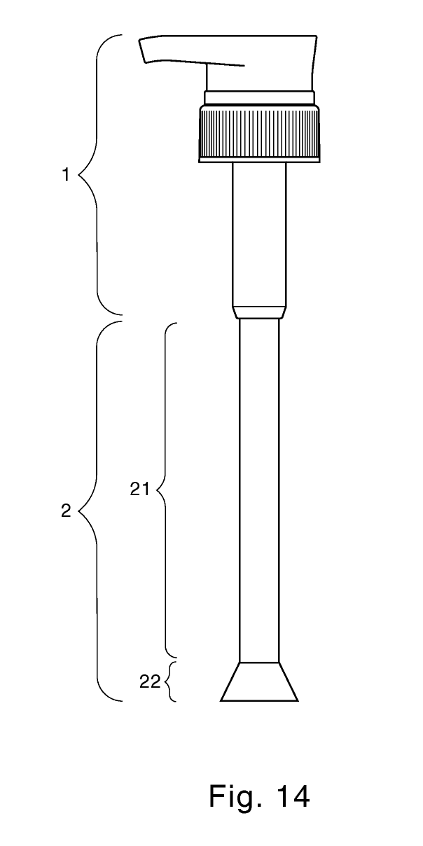

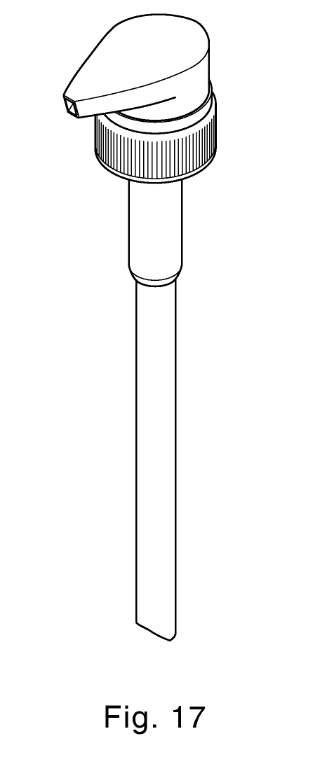

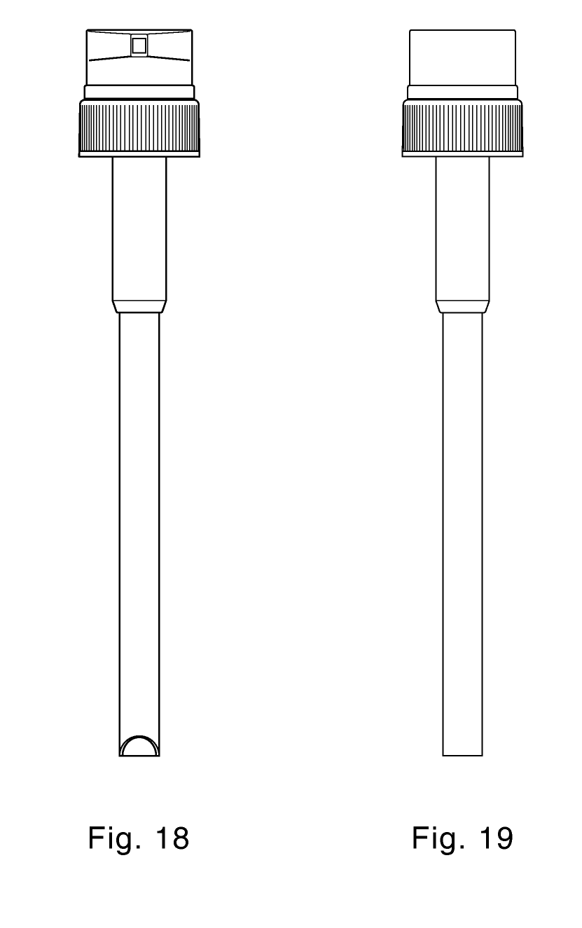

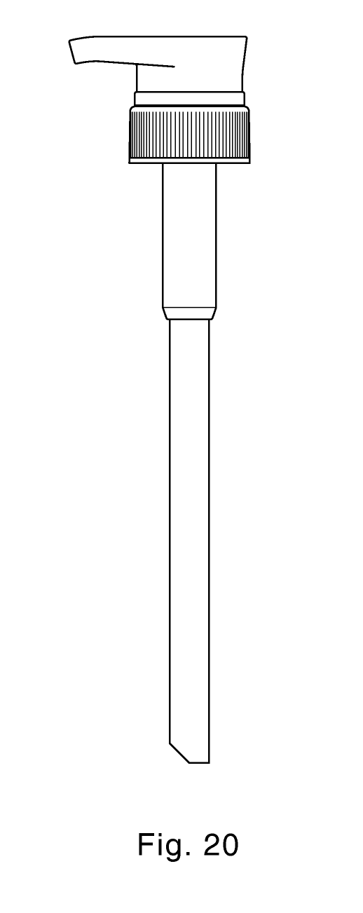

TABLE 1

| | Control | Ex. 1 | Ex. 2 | Ex. 3 | Ex. 4 |
|---|---|---|---|---|---|
| Dip tube shape | FIG. 17-20 | FIG. 13-14 | FIG. 1-6 | FIG. 1-6 | FIG. 1-6 |
| Length of the tube portion | 110 mm | 110 mm | 110 mm | 110 mm | 110 mm |
| Inner diameter of the tube | 10 mm | 10 mm | 10 mm | 10 mm | 10 mm |
| portion | | | | | |
| Inner diameter of the lower | 10 mm | 20 mm | 20 mm | 20 mm | 20 mm |
| end of the tip portion | | | | | |
| Length of the tip portion | n/a | 12 mm | 12 mm | 12 mm | 12 mm |
| Number of the cut | 1 | 0 | 2 | 2 | 2 |
| Shape of the cut | FIG. 17-20 | n/a | FIG. 1-6 | FIG. 1-6 | FIG. 1-6 |
| Height of the cut | 5 mm | n/a | 1 mm | 3 mm | 3 mm |
| Width of the cut | 5 mm | n/a | 3 mm | 6 mm | 10 mm |
| Height of the lower end of | 3 mm | 3 mm | 9 mm | 9 mm | 3 mm |
| the tip portion from the | | | | | |
| inner bottom of the package | | | | | |
| Dispensability | C | 3 | 4 | 5 | 4 |

### C: Control

1: Under 10% (excluding 10%) reduction of the product residue, compared to Control

2: From 10% to under 20% (excluding 20%) reduction of the product residue, compared to Control

3: From 20% to under 30% (excluding 30%) reduction of the product residue, compared to Control

4: From 30% to under 40% (excluding 40%) reduction of the product residue, compared to Control

5: From 40% to under 50% (excluding 50%) reduction of the product residue, compared to Control

The embodiments disclosed and represented by the previous “Ex. 1” through “Ex. 4” are the pump dispensers of the present invention. Such embodiments have advantages, for example, reducing liquid product residue at a point of aeration.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A pump dispenser with a dip tube for dispensing a liquid product from a package, wherein the dip tube comprises a tube portion and a tip portion at the lower end of the tube portion, and the dip tube has a shape such that it is spread at the tip portion.

2. The pump dispenser of claim 1, wherein the tube portion has almost same inner diameter toward its lower end where the tip portion is formed, and wherein the inner diameter of the lower end of the tip portion is bigger than the inner diameter of the tube portion.

3. The pump dispenser of claim 2, the tip portion is either: spread toward its lower end; or having almost same inner diameter toward its lower end.

4. The pump dispenser of claim 3, wherein the tip portion is spread toward its lower end.

5. The pump dispenser of claim 2, wherein the ratio of the inner diameter of the lower end of the tip portion to the inner diameter of the tube portion is from about 1.2:1 to about 5:1.

6. The pump dispenser of claim 2, wherein the ratio of the inner diameter of the lower end of the tip portion to the inner diameter of the tube portion is from about 1.5:1 to about 3:1.

7. The pump dispenser of claim 2, wherein the ratio of the inner diameter of the lower end of the tip portion to the inner diameter of the tube portion is from about 1.7:1 to about 2.5:1.

8. The pump dispenser of claim 1, wherein the tube portion is gradually spread toward the lower end where the tip portion is formed.

9. The pump dispenser of claim 1, wherein the tip portion has at least one cut.

10. The pump dispenser of claim 1, wherein the tip portion has two cuts.

11. The pump dispenser of claim 9, wherein the cut has a triangle-like and/or semicircular-like shape.

12. The pump dispenser of claim 9, wherein the cut is facing approximately to an longer edge of the package.

13. The pump dispenser of claim 1, wherein the liquid product has a viscosity of from about 2,000 mPa·s to about 200,000 mPa·s.

14. The pump dispenser of claim 1, wherein the liquid product has a viscosity of from about 5,000 mPa·s to about 100,000 mPa·s.
